(19) United States
(12) Patent Application Publication
(10) Pub. No.: US 2021/0062547 A1
(43) Pub. Date: Mar. 4, 2021

(54) Control Structure for Rotary Shaft of Electronic Lock

(71) Applicant: Jeff Chen, Chiayi City (TW)

(72) Inventor: Jeff Chen, Chiayi City (TW)

(21) Appl. No.: 16/560,249

(22) Filed: Sep. 4, 2019

(51) Int. Cl. E05B 47/00; E05B 9/02

(52) U.S. Cl. CPC E05B 47/0012; E05B 2047/002; E05B 9/02

(57) ABSTRACT

A control structure for the rotary shaft of the electronic lock contains: a case, a reduction gear, a drive gear, and multiple flexible sheets. The case includes a coupling portion, a support plate, a rotatable connection portion, an orifice, a motor, and a worm. The reduction gear includes a toothed disc. The drive gear includes a central hole, a recessed portion, and two symmetrical notches. A clamp space is defined between the multiple flexible sheets, and a stop disc includes a central aperture. The central aperture accommodates a metal sleeve formed in a rhombus shape, and the metal sleeve has four tabs formed on four corners thereof respectively, a noncircular aperture defined on a center of the metal sleeve, and a rib extending from a front end of the noncircular aperture. The metal sleeve is clamped by the multiple flexible sheets in the clamp space.

### BACKGROUND OF THE INVENTION

### Field of the Invention

The present invention relates to a control structure for a rotary shaft of an electronic lock which contains four tabs rotate configured to force a rotary knob to expand and rotate in a clamp space when a metal sleeve rotates, thus unlocking and locking the electronic lock easily.

### Description of the Prior Art

A conventional lock contains is fixed on a door plate so as to lock the plate, thus obtaining indoor safety and protection.

The lock contains an external locking element, an internal locking element, and a lock deadbolt. The lock deadbolt is arranged on a front rim of the door plate, and the internal locking element and the external locking element are mounted on an inner side and an outer side of the door plate so as to clamp the lock deadbolt, thus actuating related components of the lock. Accordingly, the key is externally inserted into or internally actuates a button indoors to unlock and lock the door plate.

The present invention has arisen to mitigate and/or obviate the afore-described disadvantages.

### SUMMARY OF THE INVENTION

The primary objective of the present invention is to provide a control structure for a rotary shaft of an electronic lock which contains four tabs rotate and force a rotary knob configured to expand and rotate in a clamp space when a metal sleeve rotates, thus unlocking and locking the electronic lock easily.

Another objective of the present invention is to provide a control structure for a rotary shaft of an electronic lock which enhances a drive rigidity and stability of a metal sleeve relative to multiple flexible sheets so as to drive a stop disc to rotate stably.

### BRIEF DESCRIPTION OF THE DRAWINGS

FIG. 1 is a perspective view showing the exploded components of a control structure for a rotary shaft of an electronic lock according to a preferred embodiment of the present invention.

FIG. 2 is a perspective view showing the exploded components of a drive gear and a stop disc of the control structure for the rotary shaft of the electronic lock according to the preferred embodiment of the present invention.

FIG. 3 is a front elevational view showing the assembly of the stop disc of the control structure for the rotary shaft of the electronic lock according to the preferred embodiment of the present invention.

FIG. 4 is a cross-sectional view showing the operation of the stop disc of the control structure for the rotary shaft of the electronic lock according to the preferred embodiment of the present invention.

FIG. 5 is another cross-sectional view showing the operation of the stop disc of the control structure for the rotary shaft of the electronic lock according to the preferred embodiment of the present invention.

FIG. 6 is also cross-sectional view showing the operation of the stop disc of the control structure for the rotary shaft of the electronic lock according to the preferred embodiment of the present invention.

FIG. 7 is still cross-sectional view showing the operation of the stop disc of the control structure for the rotary shaft of the electronic lock according to the preferred embodiment of the present invention.

FIG. 8 is another cross-sectional view showing the operation of the stop disc of the control structure for the rotary shaft of the electronic lock according to the preferred embodiment of the present invention.

### DETAILED DESCRIPTION OF THE PREFERRED EMBODIMENTS

The present invention will be clearer from the following description when viewed together with the accompanying drawings, which show, for purpose of illustrations only, a preferred embodiment in accordance with the present invention.

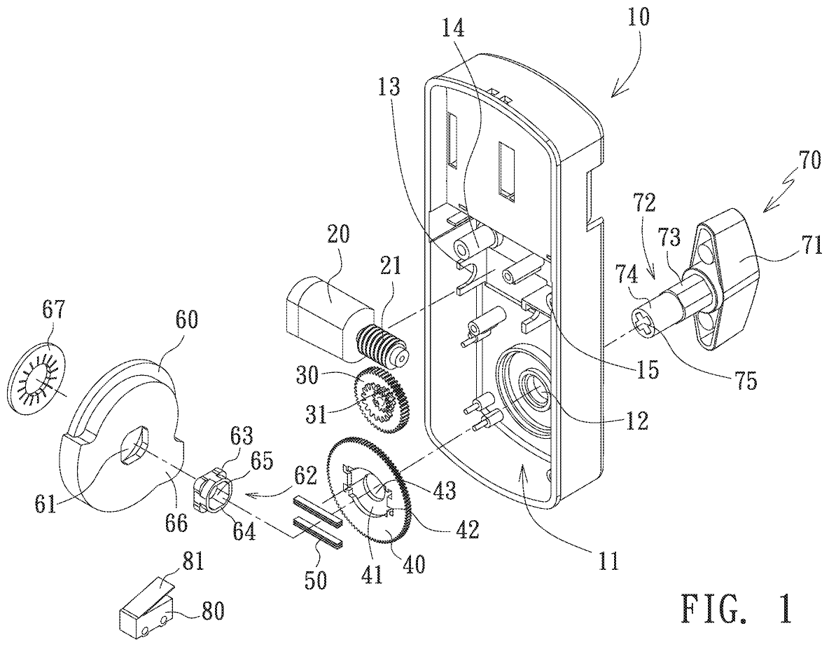

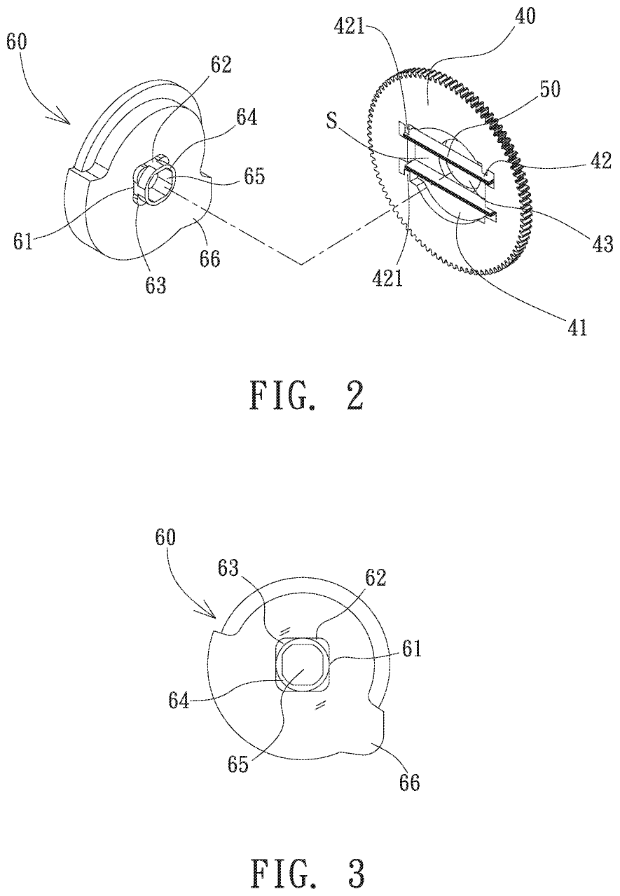

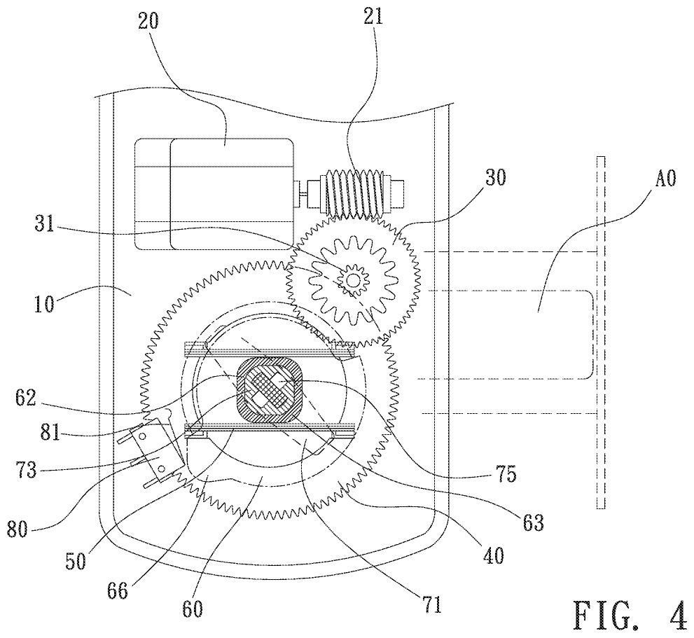

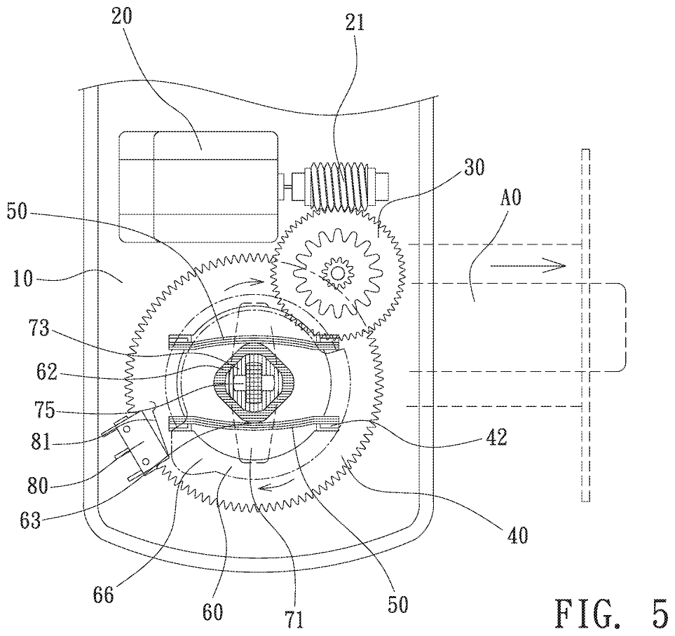

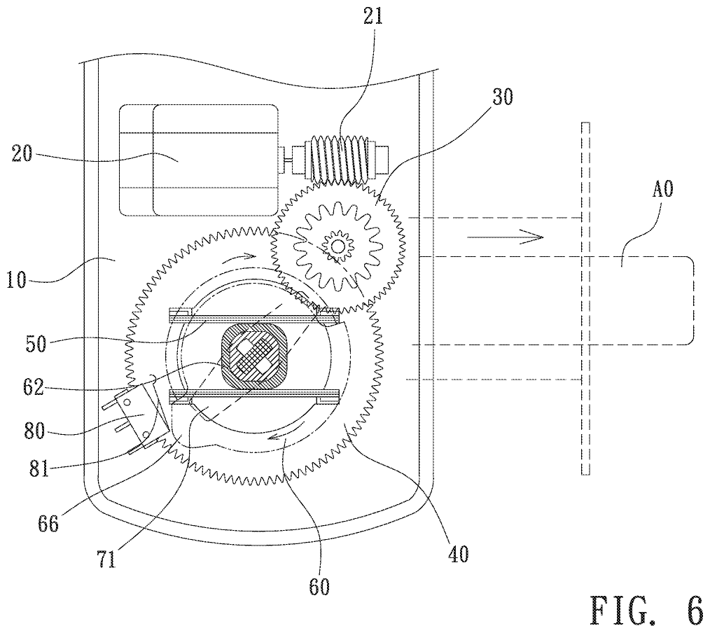

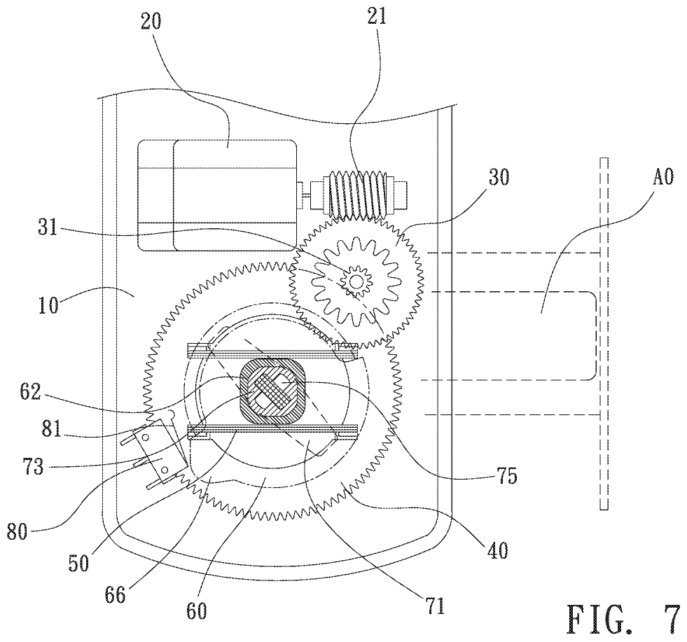

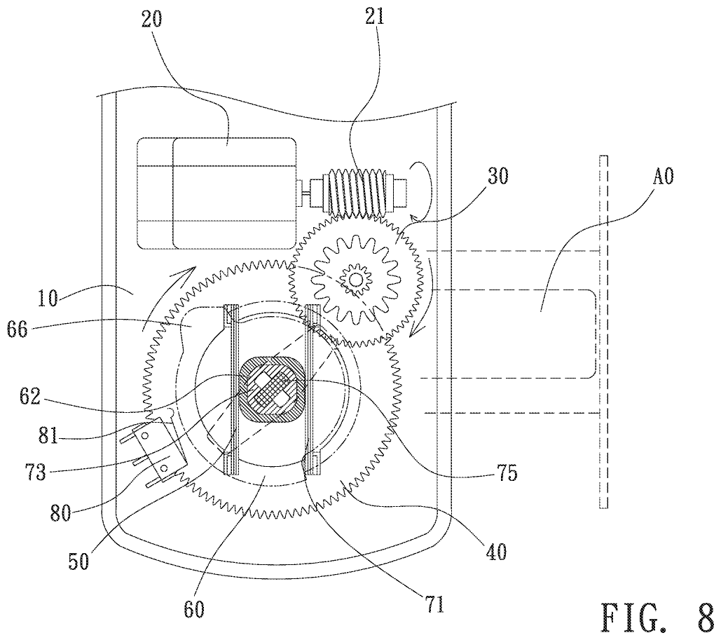

With reference to FIGS. 1-8, a control structure for a rotary shaft of an electronic lock according to a preferred embodiment of the present invention comprises:

a case 10 including an accommodation chamber 11 defined in the case 10, a coupling portion 14 arranged on a predetermined position of the accommodation chamber 11, a support plate 13 formed beside the coupling portion 14, a rotatable connection portion 15 proximate to the support plate 13, and an orifice 12 defined on a predetermined position of a bottom of the accommodation chamber 11 below the support plate 13;

a motor 20 mounted on the support plate 13 of the case 10, a worm 21 rotatably connected with an end of the motor 20 so that the motor 20 supplies a power source to drive the worm 21 to rotate;

a reduction gear 30 rotatably connected on the rotatable connection portion 15 of the case 10 and meshing with the worm 21 of the motor 20, and the reduction gear 30 including a toothed disc 31 on a side of the reduction gear 30;

a drive gear 40 including a central hole 43 defined on a center of the drive gear 40 and aligning with the orifice 12 of the case 10, the drive gear 40 meshing with the toothed disc 31 of the reduction gear 30, the driving gear 40 including a recessed portion 41 formed on a center of a front surface of the driving gear 40, two symmetrical notches 42 defined on two predetermined positions of two sides of the recessed portion 41 respectively, wherein two protrusions 421 extend from the two notches 42 individually;

multiple flexible sheets 50 engaged in the two notches 42 of the drive gear 40 individually, and the two protrusions 421 engaged with the multiple flexible sheets 50 individually, after the multiple flexible sheets 50 are positioned, a clamp space S is defined between the multiple flexible sheets 50, wherein the multiple flexible sheets 50 are three flexible sheets;

a stop disc 60 including a central aperture 61 defined on a center of the stop disc 60 and formed in a rhombus shape, a flexible ring 67 located on a side of the stop disc 60, a metal sleeve 62 formed in a rhombus shape and rotatably connected with the central aperture 61, a noncircular aperture 65 defined on a center of the metal sleeve 62, a rib 64 extending from a front end of the noncircular aperture 65, four tabs 63 formed on four corners of the metal sleeve 62 respectively, wherein the metal sleeve 62 is clamped by the multiple flexible sheets 50 in the clamp space S; the stop disc 60 including a flange 66 extending from a predetermined position of an outer rim of the stop disc 60, a micro switch 80 mounted on a side of the flange 66, the micro switch 80 including a control lever 81 fixed on a side of the micro switch 80 so that the control lever 80 abuts against the stop disc 60, wherein the stop disc 60 rotates so that the flange 66 contacts with the control lever 81 of the micro switch 80;

a rotary knob 70 including a handle 71, a drive post 72 extending from a center of the handle 71, and a noncircular portion 73 formed on the drive post 72, wherein a cross section of the noncircular portion 73 is equal to a cross section of the noncircular aperture 65 of the metal sleeve 62 so that the noncircular portion 73 is inserted through the orifice 12 of the case 10 and the central hole 43 of the drive gear 40 to be limited in the noncircular aperture 65 of the metal sleeve 62. Since diameters of the orifice 12 of the case 10 and the central hole 43 of the drive gear 40 are greater than that of the noncircular portion 73 so that the noncircular portion 73 of the rotary knob 70 limits the noncircular aperture 65 of the metal sleeve 62, and the rotary knob 70 actuates the stop disc 60 to rotate synchronously, wherein the cross section of the noncircular aperture 65 of the metal sleeve 62 is in an octagon shape, and the cross section of the noncircular portion 73 of the rotary knob 70 is in an octagon shape and is equal to the cross section of the noncircular aperture 65. The noncircular portion 73 of the rotary knob 70 has a rotation section 74 extending from an end thereof, and the drive post 72 has a cross orifice 75 defined therein so as to drive a locking head AO.

The electronic lock is unlocked or locked manually or electrically. When the electronic lock is locked manually, a user rotates the handle 71 of the rotary knob 70 so that the noncircular portion 73 actuates the noncircular aperture 65 of the metal sleeve 62 to rotate synchronously. Since the cross section of the noncircular portion 73 is equal to the cross section of the noncircular aperture 65, a torque increases to enhance a rotation force. When the stop disc 60 revolves, the four tabs 63 of the metal sleeve 62 expend and rotate in the clamp space S of the multiple flexible sheets 50, the metal sleeve 62 revolves easily by using the four tabs 63 to expand the clamp space S, thus unlocking or locking the electronic lock.

When the electronic lock is unlocked or locked electrically, the motor 20 actuates the worm 21 to mesh with and drive the reduction gear 30, and the toothed disc 31 of the reduction gear 30 actuates the drive gear 40 to revolve. When the drive gear 40 rotates and a number of the multiple flexible sheets 50 is increased, a drive rigidity and stability of the clamp space S relative to the metal sleeve 62 enhances so that the drive gear 40 drives the stop disc 60 to rotate stably, and the noncircular aperture 65 of the stop disc 60 actuates the noncircular portion 73 of the rotary knob 70 to revolve, such that the cross orifice 75 of the rotary knob 70 drives the locking head AO to lock. The locking head AO is unlocked or locked by rotating the rotary knob 70 clockwise or counterclockwise, when the stop disc 60 is rotated, the flange 66 abuts against the control lever 81 of the micro switch 80 so that an electrical signal sends to the motor 20, and the motor 20 stops rotation.

When the metal sleeve 62 rotates, the four tabs 63 force the rotary knob 70 to rotate so as to expand the clamp space S, thus unlocking or locking the rotary knob 70 easily. Preferably, the drive rigidity and stability of the clamp space S relative to the metal sleeve 62 enhances so as to drive the stop disc 60 to rotate.

While various embodiments in accordance with the present invention have been shown and described, it is clear to those skilled in the art that further embodiments may be made without departing from the scope of the present invention.

What is claimed is:

1. A control structure for the rotary shaft of the electronic lock comprising:
a case including an accommodation chamber defined in the case, a coupling portion arranged on a predetermined position of the accommodation chamber, a support plate formed beside the coupling portion, a rotatable connection portion proximate to the support plate, and an orifice defined on a predetermined position of a bottom of the accommodation chamber below the support plate; a motor mounted on the support plate of the case, a worm rotatably connected with an end of the motor so that the motor supplies a power source to drive the worm to rotate; a reduction gear rotatably connected on the rotatable connection portion of the case and meshing with the worm of the motor, and the reduction gear including a toothed disc on a side of the reduction gear; a drive gear including a central hole defined on a center of the drive gear and aligning with the orifice of the case, the drive gear meshing with the toothed disc of the reduction gear, the driving gear including a recessed portion formed on a center of a front surface of the driving gear, two symmetrical notches defined on two predetermined positions of two sides of the recessed portion respectively, wherein two protrusions extend from the two notches individually; multiple flexible sheets engaged in the two notches of the drive gear individually, and the two protrusions engaged with the multiple flexible sheets individually, after the multiple flexible sheets are positioned, a clamp space is defined between the multiple flexible sheets, wherein a stop disc including a central aperture defined on a center of the stop disc and formed in a rhombus shape;
wherein the central aperture accommodates a metal sleeve formed in a rhombus shape, and the metal sleeve has four tabs formed on four corners thereof respectively, a noncircular aperture defined on a center of the metal sleeve, a rib extending from a front end of the noncircular aperture, wherein the metal sleeve is clamped by the multiple flexible sheets in the clamp space.

2. The control structure as claimed in claim 1, wherein the multiple flexible sheets are at least two flexible sheets.

3. The control structure as claimed in claim 1, wherein the cross section of the noncircular aperture of the metal sleeve is in an octagon shape, and the cross section of the noncircular portion of the rotary knob is in an octagon shape and is equal to the cross section of the noncircular aperture.

4. The control structure as claimed in claim 1, wherein the stop disc includes a flange extending from a predetermined position of an outer rim of the stop disc, a micro switch mounted on a side of the flange, the micro switch includes a control lever fixed on a side of the micro switch so that the control lever abuts against the stop disc, wherein the stop disc rotates so that the flange contacts with the control lever of the micro switch.

5. The control structure as claimed in claim 1, wherein a rotary knob is inserted through the orifice of the case and the central hole of the drive gear to be limited in the noncircular aperture of the stop disc, the rotary knob includes a handle, a drive post extending from a center of the handle, and a noncircular portion formed on the drive post, wherein the cross section of the noncircular portion is equal to the cross section of the noncircular aperture of the metal sleeve so that the noncircular portion is inserted through the orifice of the case and the central hole of the drive gear to be limited in the noncircular aperture of the metal sleeve, since diameters of the orifice of the case and the central hole of the drive gear are greater than that of the noncircular portion so that the noncircular portion of the rotary knob limits the noncircular aperture of the metal sleeve, and the rotary knob actuates the stop disc to rotate synchronously; the noncircular portion of the rotary knob has a rotation section extending from an end thereof, and the drive post has a cross orifice defined therein so as to drive a locking head.
